(19) United States
(12) Patent Application Publication
(10) Pub. No.: US 2011/0258828 A1
(43) Pub. Date: Oct. 27, 2011

(54) Nailing Plate

(75) Inventors: William T. Moss, JR., O'Fallon, MO (US); Daniel H. Moss, Washington, MO (US)

(73) Assignee: MITEK HOLDINGS, INC., Wilmington, DE (US)

(21) Appl. No.: 12/764,168

(22) Filed: Apr. 21, 2010

(51) Int. Cl. B23P 17/04; F16B 5/00; F16B 15/00

(52) U.S. Cl. 29/428; 411/461; 403/300

(57) ABSTRACT

A nailing plate for nailing to a wood member includes a sheet of metal having a plurality of elongate teeth extending from a face of the sheet. Each tooth includes a shank portion and a tip portion. The shank portion has two straight longitudinal sides extending from the face of the sheet to the tip portion so that the longitudinal sides are substantially free of any bends. The tip portion is defined by a curved end curving continuously between the two straight longitudinal sides such that the curved end is free of any substantially straight segments. Other features are disclosed.

### FIELD OF THE INVENTION

The present invention generally relates to a nailing plate, and more particularly to a nailing plate having rounded teeth.

### BACKGROUND OF THE INVENTION

Metal connector or nailing plates having a number of teeth struck therefrom have long been used to rigidly join wood members together in abutting relation so as to form various wood structures, such as roof trusses and the like. Conventional nailing plates have proved to be effective in securing the wood members together and have permitted economical manufacture of prefabricated wood structural systems.

Many of these conventional nailing plates include teeth having long pointed tip portions configured to facilitate penetration of the teeth into the wood members without buckling or bending. While theses nailing plates are ideal for connecting wood members together, they are not ideal for reinforcing the wood members to resist splitting when the wood members are nailed to each other. Therefore, there exists a need for an improved nailing plate capable of providing structural rigidity to wood members to resist splitting.

### SUMMARY OF THE INVENTION

In one aspect, a nailing plate for nailing to a wood member generally comprises a sheet of metal having a plurality of elongate teeth extending from a face of the sheet. Each tooth includes a shank portion and a tip portion. The shank portion has two straight longitudinal sides extending from the face of the sheet to the tip portion so that the longitudinal sides are substantially free of any bends. The tip portion is defined by a curved end curving continuously between the two straight longitudinal sides such that the curved end is free of any substantially straight segments.

In another aspect, a nailing plate generally comprises a sheet of metal having a plurality of elongate teeth struck from the sheet to form openings in the sheet. One opening is formed per tooth. The teeth are arranged in pairs on a face of the sheet such that inner faces of the two teeth in each pair face each other and outer faces of the two teeth in each pair face away from each other. The two openings associated with the two teeth of each pair lie between the two teeth. The pairs of teeth and their respective openings are aligned in parallel rows that extend across a width of the sheet. The teeth and openings in each row are centered about a common axis extending across the width of the sheet.

In yet another aspect, a nailing plate for reinforcing a wood member generally comprises a sheet of metal having a plurality of elongate teeth extending from a face of the sheet. The teeth are arranged in pairs such that each tooth in a pair is disposed along a common longitudinal axis and configured such that when the nailing plate is driven into the wood member the two teeth of each pair assume a toe-nailing orientation in which the teeth slant toward each other for creating a toe-nailing effect.

In still another aspect, a nailing plate generally comprises a sheet of metal having a plurality of elongate teeth extending from a face of the sheet. Each tooth includes a shank portion and a tip portion. The shank portion has two longitudinal sides extending from the face of the sheet to the tip portion. The tip portion is defined by a curved end curving continuously between the two longitudinal sides. The tip portion has a length and the shank portion has a width. The ratio of the length of the tip portion to the width of the shank portion is between about 1 to 2 and about 1 to 3.

In another aspect, an assembly of wood members generally comprises a first wood member and a second wood member secured to the first wood member in an overlapping region of the wood members. A nailing plate is attached to one of the first and second wood members and sandwiched between the first and second wood members in the overlapping region. The nailing plate comprising a sheet of metal having a plurality to teeth extending into one of the wood members to resist splitting of one of the wood members secured to the other wood member.

In yet another aspect, a method for attaching a nailing plate to a wood member wherein at least one nailing plate is segmented from a continuous strip of nailing plates generally comprises the steps of feeding the strip of nailing plates into a frame. Bringing a leading plate of the strip into a position in the frame and segmenting the leading plate from the strip. And driving the leading plate into a face of the wood member such that the nailing plate is positioned on a single wood member without overlapping onto a second wood member. After being driven into the wood member, the two teeth of each pair assume a toe-nailing orientation in which the teeth slant toward each other for creating a toe-nailing effect.

Other objects and features will be in part apparent and in part pointed out hereinafter.

### BRIEF DESCRIPTION OF THE DRAWINGS

FIG. 1 is a perspective of a nailing plate of the present invention;

FIG. 2 is a plan view of an inner face of the nailing plate;

FIG. 3 is a side elevation of the nailing plate;

FIG. 4 is an enlarged front elevation of a tooth of the nailing plate;

FIG. 5 is a left side view of the tooth;

FIG. 6 is a plan view of the tooth;

FIG. 7 is a fragmentary perspective of a wooden pallet having a portion in phantom to show nailing plates of the present invention attached thereto;

FIG. 8 is a cross section of the nailing plate driven into a wood member;

FIG. 9 is a perspective of a second embodiment of a nailing plate of the present invention;

FIG. 10 is a side elevation of an apparatus for driving the nailing plates into wood members;

FIG. 11 is a front elevation of the apparatus; and

FIG. 12 is an enlarged front elevation of the apparatus.

Corresponding reference characters indicate corresponding parts throughout the drawings.

### DESCRIPTION OF THE PREFERRED EMBODIMENTS

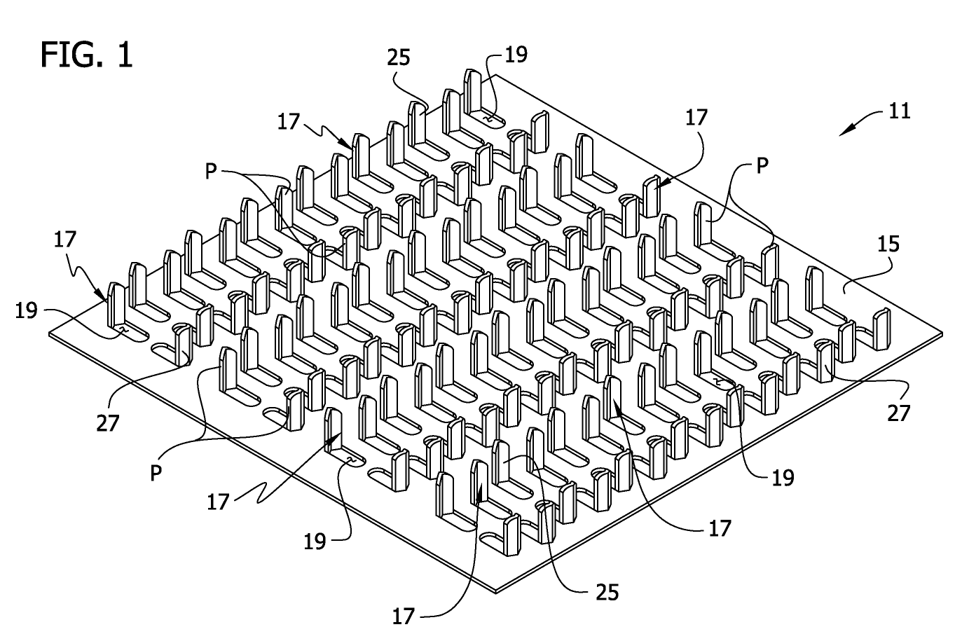

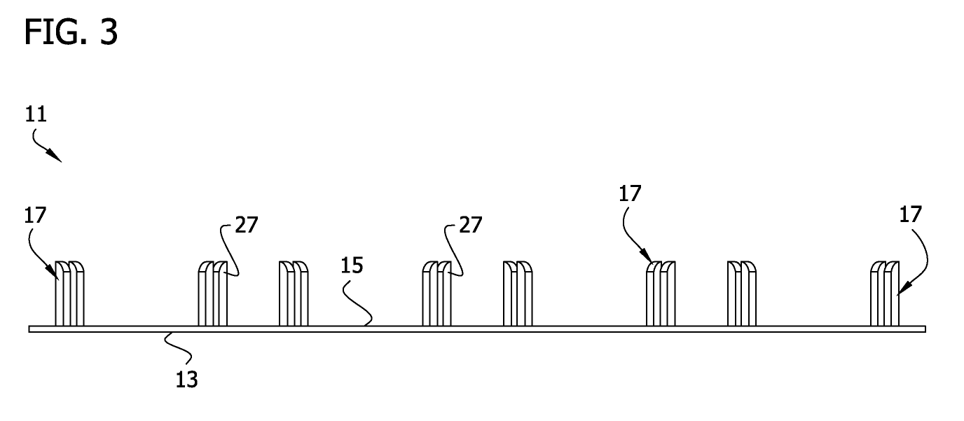

Referring to the FIGS. 1-3, a nailing plate of the present invention comprises a metal sheet, generally indicated by reference numeral 11, having an outer face 13 and an inner face 15. Elongate teeth, indicated generally at 17, are struck or punched from the sheet 11 and extend perpendicularly from the sheet, each tooth leaving an elongate vacated opening or slot 19 which generally conforms to the tooth shape. The teeth 17 are struck from the sheet 11 in pairs P and arrayed in a successive series of generally parallel staggered rows R1-R14, and generally parallel columns C1-C4. The rows R1-R14 are staggered relative to one another by an offset O between about 0.045 and about 0.09 inches. In the illustrated embodiment, the offset O is about 0.060 inches. The nailing plate shown in the illustrated embodiment is 4 in×4 in. However, the nailing plate can be sized in a number of different sizes as needed. Also, one or more of the rows R1-R14 may be removed to provide room on the sheet 11 for marking the plate, such as with a company name/logo or product identification. The removal of rows can also increase the overall bending strength of the plate since the slots 19 in the sheet 11 left by the teeth 17 are replaced with sheet material.

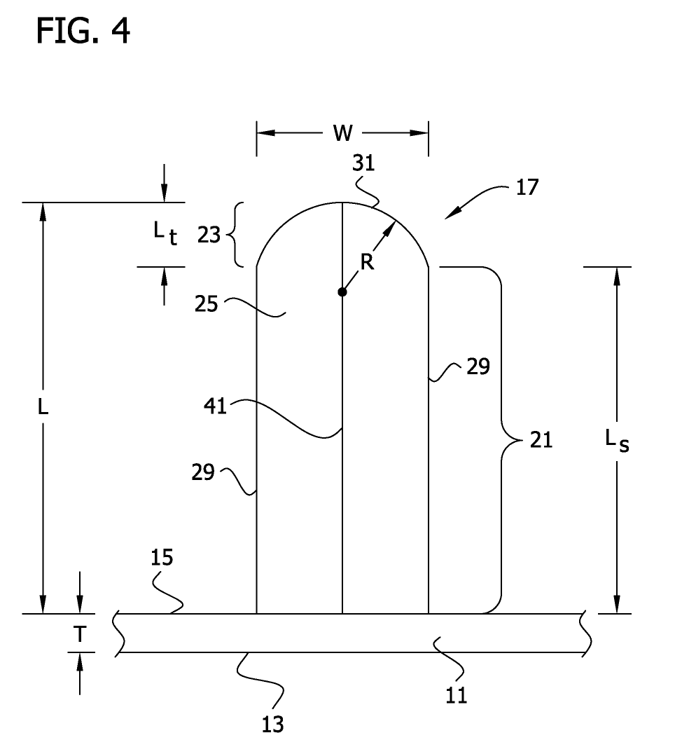

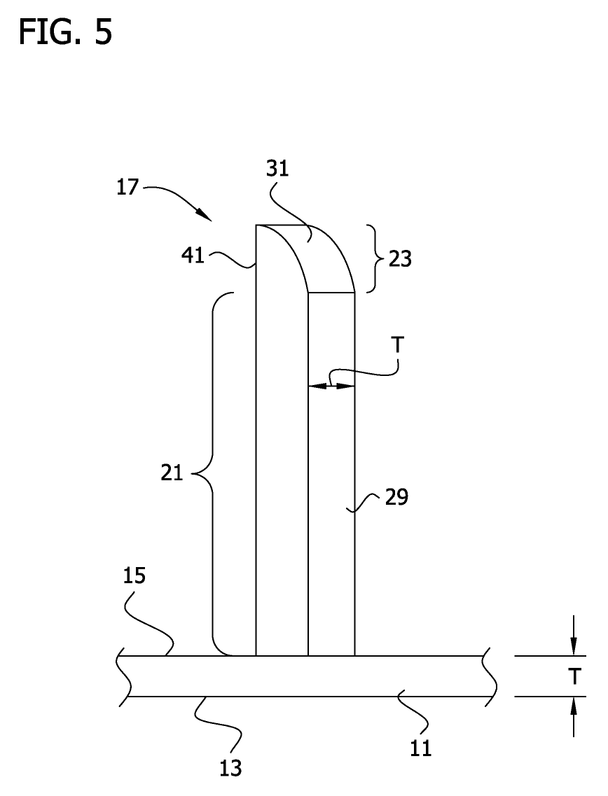

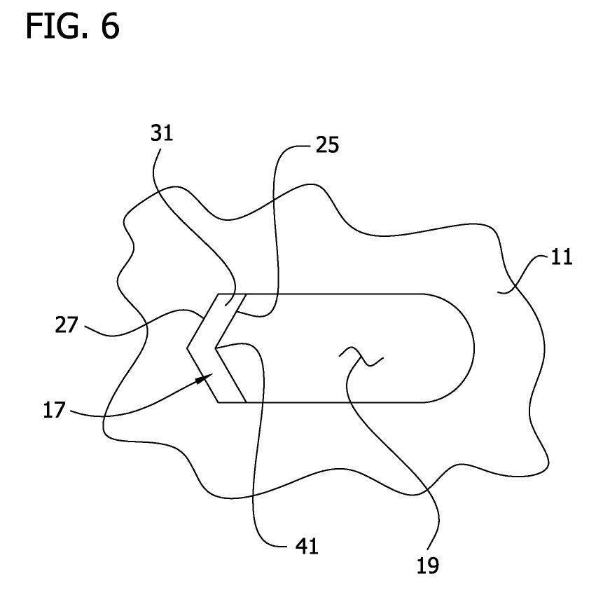

The teeth 17 in each pair P are struck such that inner faces 25 of the teeth face one another while outer faces 27 of the teeth face away from each other. Each tooth 17 is of a substantially identical configuration. Referring to FIGS. 4-6, each tooth 17 comprises a shank portion 21 extending upwardly from the inner face 15 of the sheet 11 at one end of the slot 19, and a tip portion 23 extending from the shank portion. The shank portion 21 extends generally perpendicularly from the sheet 11 and has substantially parallel straight lateral sides or edges 29 which are connected by a curved end 31 of the tip portion 23. The curved end 31 curves continuously between the lateral edges 29. In the illustrated embodiment, the edges 29 extend substantially parallel to each other along the length of the shank portion 21. However, the edges 29 can have a small taper (e.g., 0.25 degrees) to aid in removing the teeth from a die when the teeth are formed from the sheet 11. In one embodiment, the overall length L of each tooth 17 is about 0.287 in.; wherein the length Lₛ of the shank portion 21 is about 0.242 in.; and the length Lₜ of the tip portion 23 is about 0.045 in. The width W of the shank portion 21 of each tooth 17 is about 0.12 in. The radius of curvature R of the curved end 31 of the tip portion 23 is about 0.0625 in. (the diameter of curvature thus being about 0.125 in.). The ratio of the diameter of curvature of the curved end 31 of the tip portion 23 to the length Lₜ of the tip portion is between about 2 to 1 and about 3 to 1. In a preferred embodiment, the ratio is about 2.7 to 1. The ratio of the length Lₜ of the tip portion 23 to the width W of the shank portion 21 is between about 1 to 2 and about 1 to 3. In a preferred embodiment, the ratio is about 1 to 2.6. These ratios facilitate penetration of the teeth 17 into a wood member without buckling but still allow the teeth to bend into a “toe-nailing” orientation as they are driven into the wood, as will be explained in greater detail below.

Each tooth 17 is crimped along its medial longitudinal axis, such that the tooth has a bend 41 extending along the length of each tooth to form a generally V-shaped cross section (FIGS. 4-6). The included angle of the groove formed by the crimped surface is about 120 degrees and serves to stiffen the tooth fore and aft relative to the slot 19. This angle may be varied so as to be more or less than 120 degrees. The crimped configuration of the teeth 17 also creates sharpness at the tip portion 23 to facilitate penetration of the nailing plate into the wood member.

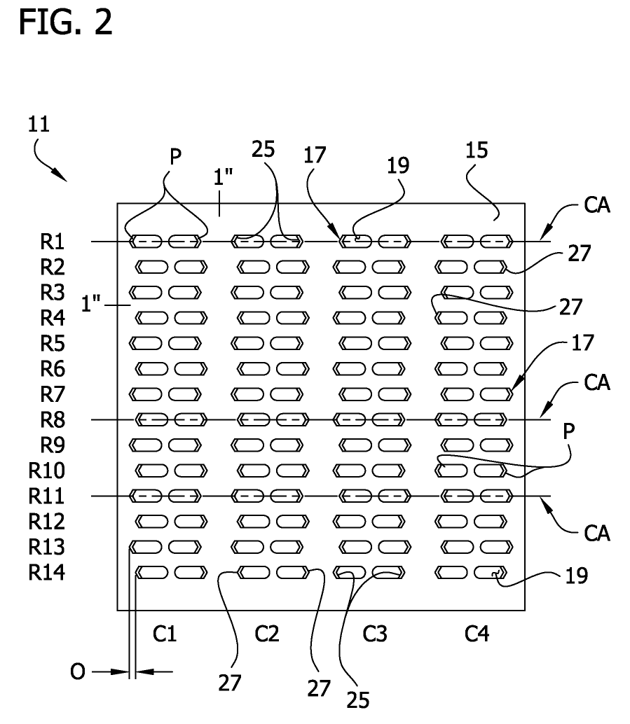

Preferably, the sheet 11 is fabricated from hot-dripped galvanized, 22 gauge, mild commercial steel having a thickness T of about 0.027 in. About 6-8 teeth 17 are struck from each square inch of sheet area (FIG. 2). Each tooth 17 has a ratio of thickness T to shank portion width W between about 1 to 4 and about 1 to 5. In a preferred embodiment, the ratio is about 1 to 4.4 This ratio facilitates a measured amount of bending of each tooth 17 when the nailing plate is driven into the wood member. Furthermore, each tooth 17 has a ratio of its thickness squared T² to its length squared L² of about 0.009 and a ratio of its length L to its thickness squared T² equal to or less than about 40. These ratios are a comparison of the proportions of the tooth which to a large degree determine the bending and buckling characteristics of the tooth 17. The above-mentioned ratios result in a tooth 17 of this invention having a sufficient resistance to buckling while providing a measured amount of bending when the nailing plate is driven into a wood member.

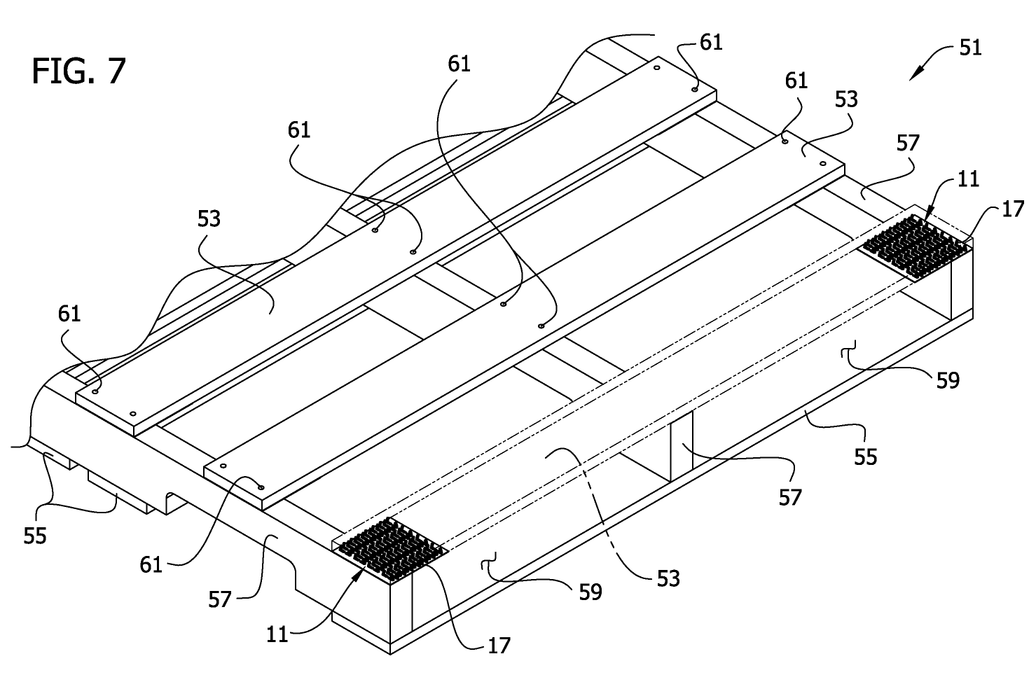

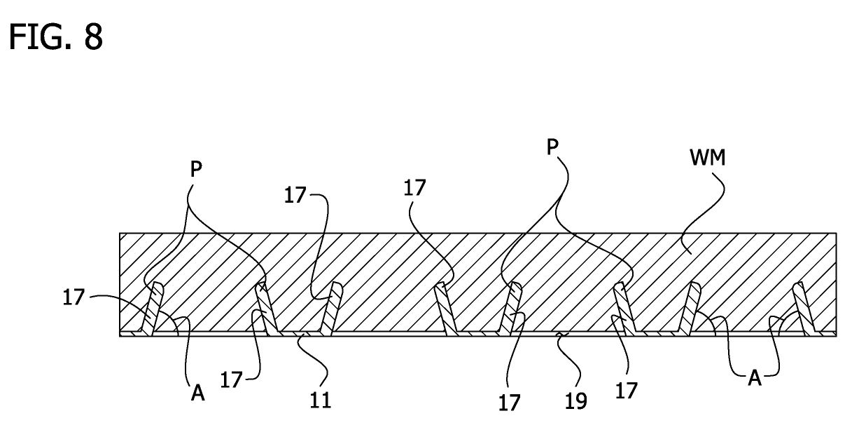

The nailing plate of the present invention is particularly used to reinforce and repair wood members attached to one another to form a wood assembly, e.g., wooden pallets and crates. Referring to FIGS. 7 and 8, a standard pallet 51 comprises a plurality of top slats 53 attached to a plurality of bottom slats 55 by spaced apart bearers 57 disposed between the top and bottom slats. In the illustrated embodiment, the slats 53, 55 are nailed to the bearers 57 by nails 61 at regions where the slats overlap the bearers. The bearers 57 and slats 53, 55 are spaced apart a sufficient distance to allow forks of a forklift (not shown) to be received through openings 59 in the pallet to grasp and lift the pallet for transporting the pallet. The nailing plates are nailed to a bottom surface of the top slats 53 and a top surface of the bottom slats 55 at the ends of the slats. In a preferred embodiment, the teeth 17 of the nailing plates extend transverse to the grain of the wood fibers of the slats 53, 55. The rounded tip portions 23 of the teeth 17 cut or tear through the wood fibers rather than spreading them apart which would aggravate splitting of the wood. This reduces the tendency of boards and slats to check and pop off as would be the case if conventional nailing plates with long pointed tip portions were used. As the teeth 17 are being driven into the wood members, the relatively large ratio of the diameter of curvature of the curved end 31 of the tip portion 23 to the length Lₜ of the tip portion, and the relatively small ratio of the length Lₜ of the tip portion to the width W of the shank portion 21, along with the relatively small ratio of the shank portion thickness T to the shank portion width W, cause the two teeth of each pair P to assume a “toe-nailing” orientation in which the teeth slant toward each other between about 90 and about 40 degrees to create a toe-nailing effect to counteract nominal forces on the nailing plate tending to pull the nailing plate away from the slats 53, 55. The slanted orientation of the teeth 17 resists splitting of the slats 53, 55 which can occur as a result of the nails 61 being driven into the slats and separating the fibers.

In FIG. 8 the teeth 17 are shown in their driven configuration inside a wood member WM. In the illustrated embodiment the teeth 17 are slanted such that they extend from the sheet 11 at an angle A of about 45 degrees. Conventional nailing plates having long pointed tip portions are designed to penetrate wood members without bending. It will be understood that the exact angle of the teeth 17 in the wood members is not always the same and depends on the type of wood. Thus it will be understood that the tooth angle shown in the figures is somewhat variable.

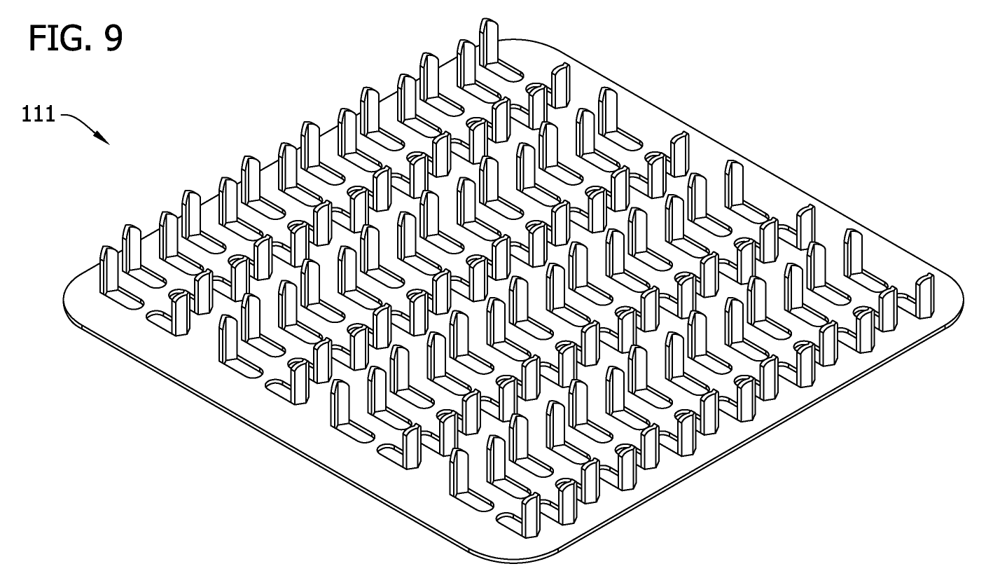

In a second embodiment of the invention, a nailing plate of the present invention comprises a metal sheet 111 having rounded corners (FIG. 9). Every other element of the nailing plate is identical to the nailing plate of the first embodiment. The rounded corners provide an added safety benefit over the square corners of the first embodiment.

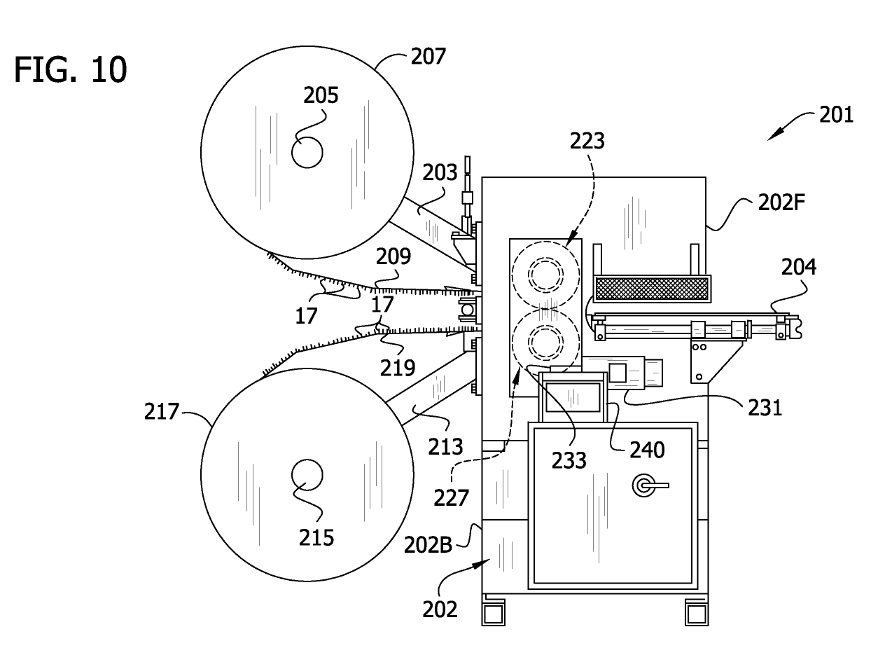

FIGS. 10-12 illustrate a press, generally designated 201, comprising a frame 202 having a front 202F and a back 202B. A work surface 204 is coupled to the front 202F of the frame 202. An upper arm 203 extends from the back 202B of the frame 202 and has a spindle 205 at its outer end carrying a supply in the form of a coil 207 of a strip 209 of nailing plates. The nailing plates have the same configuration as the nailing plates described above. A lower arm 213 extends from the back 202B of the frame 202, below the upper arm 203, and has a spindle 215 at its outer end carrying another supply in the form of a coil 217 of a strip 219 of nailing plates (which may be the same as strip 209). Each strip 209, 219 comprises a multiplicity of plates integrally connected end-to-end lengthwise of the strip. A leading plate of each strip 209, 219 is adapted to be segmented from the strip and driven into a piece of wood by the press 201 for reinforcing the piece of wood against splitting.

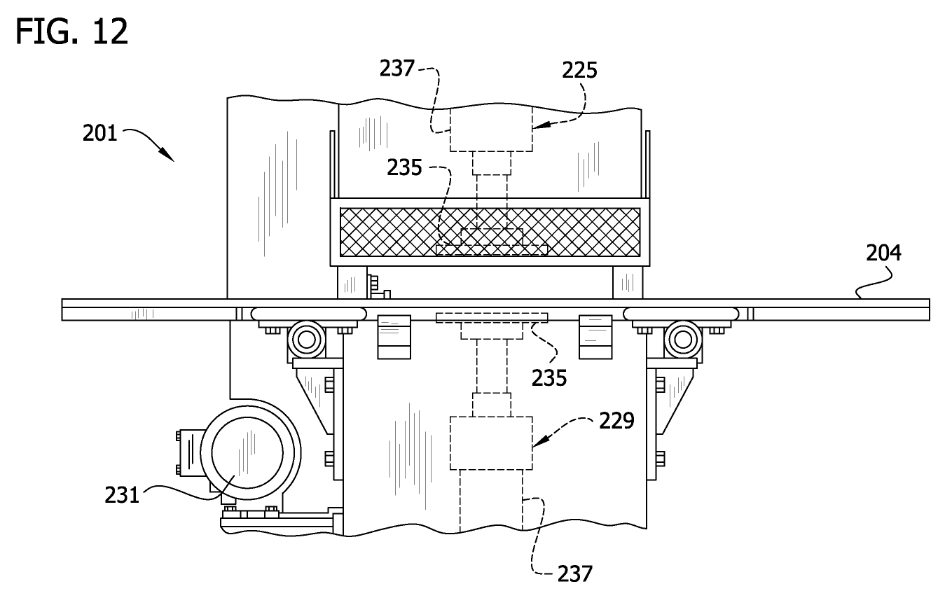

The press 201 includes an upper feeder 223 operable to feed forward the upper strip 209 of nailing plates from the upper coil 207 with the teeth 17 of the plates extending down to bring the leading plate of the upper strip to a position for being segmented from the upper strip and driven downward. An upper driver 225 (FIG. 12) mounted in the frame 202 functions to drive the segmented plates in a downward direction. Mounted in the frame 201 directly below the upper feeder is a lower feeder 227 operable to feed forward the lower strip 219 of nailing plates from the lower coil 217 with the teeth 17 of the plate extending up to bring the leading plate of the lower strip to a position for being segmented from the lower strip and driven upward. A lower driver 229 mounted in the frame 201 functions to drive the segmented plate in an upward direction.

Each feeder 223, 227 generally comprises a roll rotatable on a horizontal axis contacting the respective strip 209, 219. The roll is rotated by a motor 231 via a drive 233 to advance the respective strip one nailing plate length during each cycle of operation of the press 201.

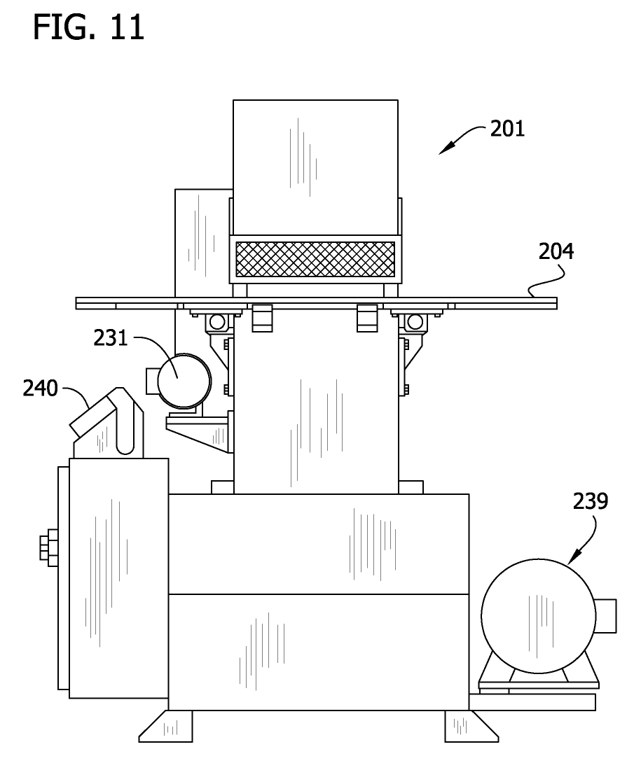

Each of the nailing plate drivers 225, 229 comprises a presser platen 235 on the plunger of a hydraulic cylinder 237, the upper presser platen being movable down for pressing down a nailing plate segmented from the upper strip 209 into a wood member placed on the work surface 204, and the lower presser platen being movable up for pressing up a nailing plate segmented from the lower strip 219 into a wood member placed on the work surface. At 239 is an indicated means for supplying the hydraulic cylinders with hydraulic fluid under pressure and controlling them (FIG. 11). A control panel 240 is provided for setting the operating parameters of the apparatus 201. The apparatus as thus far described corresponds essentially to that disclosed in co-assigned U.S. Pat. Nos. 6,256,862 and 6,330,963, both of which are incorporated herein by reference.

In use, the press 201 advances at least one of the strips 209, 219 from the coils 207, 217 through the frame 202. In the case of the upper strip 209, the teeth 17 of the nailing plates in the upper strip will extend downward. In the case of the lower strip 219, the teeth 17 of the nailing plates will extend upward. A leading plate of the strip 209, 219 is then brought into a position in the frame 202 and is segmented from the strip. The upper driver 225 drives the leading plate in the upper strip 209 downward, and conversely the lower driver 229 drives the leading plate in the lower strip 219 upward into a face of a wood member placed on the work surface 204. In U.S. Pat. Nos. 6,256,862 and 6,330,963, the nailing plates are driven into two adjacent wood members to attach the wood members together. It will be understood, however, that the same or similar press can be used to drive a nailing plate of the present invention into a single wood member without overlapping onto a second wood member. Such a modification is achieved through the placement of only one wood member within the path of the nailing plate being driven. As discussed above, the two teeth 17 of each pair P of teeth on the nailing plate will assume a toe-nailing orientation in the wood member in which the teeth slant toward each other for creating a toe-nailing effect. This slanted orientation of the teeth 17 resists splitting of the wood members which can occur when fasteners such as nails are driven into the wood members.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A nailing plate for nailing to a wood member, the nailing plate comprising a sheet of metal having a plurality of elongate teeth extending from a face of the sheet, each tooth including a shank portion and a tip portion, the shank portion having two straight longitudinal sides extending from the face of the sheet to the tip portion so that the longitudinal sides are substantially free of any bends, the tip portion being defined by a curved end curving continuously between the two straight longitudinal sides such that the curved end is free of any substantially straight segments.

2. The nailing plate of claim 1 wherein the longitudinal sides of the shank portion extend substantially parallel to each other substantially along an entire length of the shank portion.

3. The nailing plate of claim 2 wherein the longitudinal sides extend from the face of the sheet at substantially right angles.

4. The nailing plate of claim 1 wherein the teeth are arranged in pairs and configured so that when the nailing plate is driven into the wood member, the two teeth of each pair assume a toe-nailing orientation in which the teeth slant toward each other for creating a toe-nailing effect.

5. The nailing plate of claim 4 wherein each tooth of said pair of teeth in said toe-nailing orientation extends from the face of the sheet at an acute angle between about 90 and 40 degrees.

6. The nailing plate of claim 5 wherein said acute angle is about a 45 degree angle.

7. The nailing plate of claim 1 wherein the tip portion has a diameter of curvature and a length, the ratio of the diameter of curvature to the length being between about 2 to 1 and about 3 to 1.

8. The nailing plate of claim 7 wherein the shank portion has a width, the ratio of the length of the tip portion to the width of the shank portion being between about 1 to 2 and about 1 to 3.

9. The nailing plate of claim 8 wherein each tooth has a thickness, the ratio of the thickness of the tooth to the width of the shank portion being between about 1 to 4 and about 1 to 5.

10. The nailing plate of claim 1 wherein each tooth is struck from the sheet forming an opening in the sheet, the teeth being arranged in pairs such that the two openings associated with the two teeth in each pair lie between the two teeth.

11. The nailing plate of claim 1 wherein the sheet has rounded corners.

12. A nailing plate comprising a sheet of metal having a plurality of elongate teeth struck from the sheet to form openings in the sheet, one opening per tooth, the teeth being arranged in pairs on a face of the sheet such that inner faces of the two teeth in each pair face each other and outer faces of the two teeth in each pair face away from each other, and such that the two openings associated with the two teeth of each pair lie between the two teeth, the pairs of teeth and their respective openings being aligned in parallel rows that extend across a width of the sheet, the teeth and openings in each row being centered about a common axis extending across the width of the sheet.

13. The nailing plate of claim 12 wherein the rows are spaced at intervals along a length of the sheet and are staggered relative to one another widthwise of the sheet.

14. The nailing plate of claim 13 wherein the rows are staggered by a distance between about 0.045 and about 0.09 inches.

15. A nailing plate for reinforcing a wood member, the nailing plate comprising a sheet of metal having a plurality of elongate teeth extending from a face of the sheet, the teeth being arranged in pairs such that each tooth in a pair is disposed along a common longitudinal axis and configured such that when the nailing plate is driven into the wood member the two teeth of each pair assume a toe-nailing orientation in which the teeth slant toward each other for creating a toe-nailing effect.

16. The nailing plate of claim 15 wherein each tooth of said pair of teeth in said toe-nailing orientation extends from the face of the sheet at an acute angle between about 90 and 40 degrees.

17. The nailing plate of claim 16 wherein said acute angle is about a 45 degree angle.

18. The nailing plate of claim 15 wherein each tooth is struck from the sheet forming an opening in the sheet, the two openings associated with the two teeth in each pair lying between the two teeth.

19. A nailing plate comprising a sheet of metal having a plurality of elongate teeth extending from a face of the sheet, each tooth including a shank portion and a tip portion, the shank portion having two longitudinal sides extending from the face of the sheet to the tip portion, the tip portion being defined by a curved end curving continuously between the two longitudinal sides, the tip portion having a length and the shank portion having a width, the ratio of the length of the tip portion to the width of the shank portion being between about 1 to 2 and about 1 to 3.

20. The nailing plate of claim 19 wherein the tip portion has a diameter of curvature, the ratio of the diameter of curvature of the tip portion to the length of the tip portion being between about 2 to 1 and about 3 to 1.

21. The nailing plate of claim 20 wherein each tooth has a thickness, the ratio of the thickness of the tooth to the width of the shank portion being between about 1 to 4 and about 1 to 5.

22. An assembly of wood members, comprising:
a first wood member;
a second wood member secured to the first wood member in an overlapping region of the wood members; and
a nailing plate attached to one of said first and second wood members and sandwiched between the first and second wood members in the overlapping region, the nailing plate comprising a sheet of metal having a plurality to teeth extending into one of the wood members to resist splitting of said one of the wood members secured to the other wood member.

23. The assembly of claim 22 wherein the second wood member is secured to the first wood member by nails.

24. The assembly of claim 23 wherein the assembly is one of a pallet and a crate.

25. The assembly of claim 22 wherein the nailing plate is attached such that the teeth of the nailing plate penetrate the wood member against a grain of the wood member.

26. The assembly of claim 22 wherein the plurality of teeth extend from a face of the sheet, the teeth being arranged in pairs such that each tooth in a pair is disposed along a common longitudinal axis and configured such that the two teeth of each pair assume a toe-nailing orientation in which the teeth slant toward each other creating a toe-nailing effect.

27. The assembly of claim 26 wherein each tooth of said pair of teeth in said toe-nailing orientation extends from the face of the sheet at an acute angle between about 90 and 40 degrees.

28. The assembly of claim 26 wherein each tooth includes a shank portion and a tip portion, the shank portion having two longitudinal sides extending from the face of the sheet to the tip portion, the tip portion being defined by a curved end curving continuously between the two longitudinal sides, the tip portion having a length and the shank portion having a width, the ratio of the length of the tip portion to the width of the shank portion being between about 1 to 2 and about 1 to 3.

29. The assembly of claim 28 wherein the tip portion has a diameter of curvature, the ratio of the diameter of curvature of the tip portion to the length of the tip portion being between about 2 to 1 and about 3 to 1.

30. The assembly of claim 29 wherein each tooth has a thickness, the ratio of the thickness of the tooth to the width of the shank portion being between about 1 to 4 and about 1 to 5.

31. The assembly of claim 22 wherein each tooth is struck from the sheet forming an opening in the sheet, the teeth being arranged in pairs such that the two openings associated with the two teeth in each pair lie between the two teeth.

32. A method of attaching a nailing plate to a wood member wherein at least one nailing plate is segmented from a continuous strip of nailing plates, each nailing plate having teeth extending from a face of the nailing plate, the teeth being arranged in pairs such that each tooth in a pair is disposed along a common longitudinal axis, the nailing plates being connected end-to-end lengthwise of the strip, the method comprising the steps of:
feeding the strip of nailing plates into a frame;
bringing a leading plate of the strip into a position in the frame and segmenting the leading plate from the strip; and
driving the leading plate into a face of said wood member such that the nailing plate is positioned on a single wood member without overlapping onto a second wood member, the two teeth of each pair assuming a toe-nailing orientation in which the teeth slant toward each other for creating a toe-nailing effect.
